(19) United States
(12) Patent Application Publication
(10) Pub. No.: US 2012/0132081 A1
(43) Pub. Date: May 31, 2012

(54) PORTABLE INFUSED BEVERAGE STORAGE CONTAINER

(76) Inventors: Linda Juengst, Saint Louis, MO (US); Angela Hall, St. Louis, MO (US)

(21) Appl. No.: 12/955,986

(22) Filed: Nov. 30, 2010

(51) Int. Cl. C12G 3/00; B65D 21/00

(52) U.S. Cl. 99/275; 220/23.87

(57) ABSTRACT

An infused beverage storage container to enable a person to create a fruit infused alcoholic beverage within the same container used for storage and dispensing. The infused beverage storage container includes a holding box with a plurality of sides, where the plurality of sides compose a peripheral edge of the holding box, a set of handle acceptors attached to a set of opposing sides, a top attached to an upper portion of the holding box, and a set of handlebars engaged within the set of handle acceptors to lift the infused beverage storage container. The infused beverage storage container further includes an infusion jar resting within the holding box, a lid fastened to the infusion jar and extending from an opening within the top, and a combination of ingredients to create an infused beverage wherein the infused beverage is housed within the infusion jar and dispensed after removing the lid.

### BACKGROUND OF THE INVENTION

1. Field of the Invention

The present invention relates to an infused beverage storage container to enable a person to create a fruit infused alcoholic beverage within the same container used for both storage and dispensing. Further the infused beverage storage container includes means to lift and transport the apparatus.

2. Description of Related Art

The popularity of infusing and brewing of alcoholic beverages at home has grown tremendously in recent years. Currently, flavored beers and infused alcohols are available from distributors in pre-packaged bottles. While the pre-bottled beverages are well liked, many people enjoy the ability to control the ingredients added to the mix and to select the quantities and amounts used. The home brewers appreciate controlling their ingredients and ensuring that no preservatives or artificial flavors are used. For example, some people may prefer to home brew a beer with more hops, or to include a particular spice or fruit. Likewise, individuals who like to infuse alcohols may add spices like cinnamon or vanilla or opt for fruit flavorings like orange, lemon, or even mango, while avoiding artificial flavorings or sweeteners. Whatever the preferences, the availability for home brewing is growing and only seems to continue in the coming years.

While the popularity of home mixing is great, the availability of holding containers is limited. Home brewers must actively seek the equipment needed for their beverages. Some specialty stores or internet websites may carry infusion containers, or beer brewing kits, but often the items are difficult to find. Similarly, the storage and distribution containers are limited, especially one that may be portable. Most of the home brewing equipment is meant to remain stationary either due to size, fragility or sheer number of pieces. This is inconvenient for those individuals who not only like to home mix but also entertain others at home parties, get-togethers or picnics.

It would be beneficial in the art to provide a home mixing device which enables a person to create their own infused alcohols while allowing them the ability to distribute the mix from the same container used for mixing. It would also be desirable to provide the mixing container with means for transport.

### SUMMARY OF THE INVENTION

It is an object of the present invention to provide a home infusion method wherein a user may distribute the infused beverage from the same container used for infusion.

Another object of the present invention is to provide a set of handlebars to enable the user to lift and transport the apparatus from one location to another

In view of the foregoing disadvantages inherent in the prior art, the general purpose of the present disclosure is to provide an infused beverage storage container comprising a holding box with a plurality of sides, where the plurality of sides compose a peripheral edge of the holding box, a set of handle acceptors attached to a set of opposing sides, a top attached to an upper portion of the holding box, and a set of handlebars engaged within the set of handle acceptors to lift the infused beverage storage container. The infused beverage storage container further includes an infusion jar resting within the holding box, a lid fastened to the infusion jar and extending from an opening within the top, and a combination of ingredients to create an infused beverage wherein the infused beverage is housed within the infusion jar and dispensed after removing the lid.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of an infused beverage storage container in accordance with an exemplary embodiment of the present invention;

FIG. 2 depicts a side view of an infused beverage storage container in accordance with an exemplary embodiment of the present invention; and

FIG. 3 depicts a top view of an infused beverage storage container in accordance with an exemplary embodiment of the present invention.

Like reference numerals refer to like parts throughout the description of several views of the drawings.

### DETAILED DESCRIPTION OF THE DRAWINGS

The present invention relates to an infused beverage storage container to enable a person to create a fruit infused alcoholic beverage within the same container used for both storage and dispensing. The present invention discloses an infused beverage storage container comprising a holding box equipped with a set of handlebars also including an infusion jar to allow individuals to infuse an alcohol with their favorite flavorings. The infused beverage storage container enables the users to not only infuse their preferred flavoring into the alcohol but also to transport the container easily from one location to another.

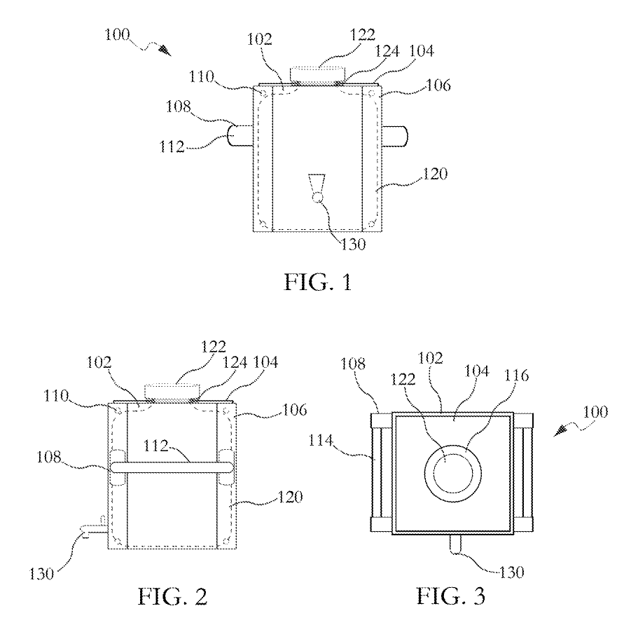

Turning now descriptively to the drawings, referring to FIG. 1, a perspective view of an infused beverage storage container (100) is shown in accordance with an exemplary embodiment of the present invention. The infused beverage storage container (100) comprises a holding box (102) in a generally square shape but may also be available in a cylindrical shape. The holding box (102) includes a plurality of sides (103) (hereinafter sides) or walls which compose the peripheral edges the holding box (102). The holding box (102) may be composed of a resin, plastic or another sturdy material to support a box frame. Resting against an upper portion of the holding box (102) may be a top (104). The top (104) may be composed of the same material used for the holding box (102).

If in the square shape, the holding box (102) may include a plurality of reinforcement bars (106) at each corner. The reinforcement bars (106) may secure the holding box (102) together and ensure that the holding box (102) does not fall apart or loosen while moving. To secure the reinforcement bars (106) against the sides (103) of the holding box (102) may be a plurality of attachment means (110) (hereinafter attachment means). The attachment means (110) may be a set of screws, bolts, pegs and the like; generally a device to tightly fasten the reinforcement bars (106) against the sides (103).

Accordingly, on a set of opposing sides (103) of the holding box (102) may be a set of handle acceptors (108). The set of handle acceptors (108) extend laterally from the holding box (102) at equal heights. In a central portion of the set of handle acceptors (108) may be a hole to accept an end (112) of a handlebar (shown in FIG. 2). The end (112) fits securely within the hole to ensure that the handle bar will not slide or shift during transport.

Within the holding box (102) may be an infusion jar (120) including a lid (122). The infusion jar (120) may comprise a cylindrical body large enough to hold a large quantity of liquids and a combination of ingredients used for an infused beverage. The infusion jar (120) may be comprised of glass, plastic, aluminum or another material sufficient to create a waterproof container. While the infusion jar (120) rests within the holding box (102), a spray foam may be used to fill the gaps between the infusion jar (120) and the sides (103) of the holding box (102). The spray foam secures and insulates the infusion jar (120) within the holding box and prevents light from passing into the infusion jar (120). A spigot 130 may provided on one side of the holding box (102) for that provides for the release infused beverage from within the infusion jar (120).

The infusion jar (120) may include a threaded neck (124) to receive the lid (122), and enables the lid (122) to screw in place. The threaded neck (124) and the lid (122) may extend through an opening (shown in FIG. 3) within the top (104) of the holding box (102). The opening may permit the user access to the infusion jar's (120) contents while remaining in the holding box (102). The lid (122) may be fully removable or the lid (122) may be a flip-top lid wherein a portion remains joined to a non-threaded neck. The lid (122) creates an airtight seal when screwed onto the threaded neck (124). The airtight seal prevents spills and messes so keep the contents of the infusion jar (120) within the infusion jar (120) during transport. The airtight seal also ensures that no bacteria enter the infusion jar (120) which could contaminate the contents.

Referring now to FIG. 2, a side view of the infused beverage storage container (100) is shown in accordance with an exemplary embodiment of the present invention. FIG. 2 illustrates the handlebar (114) engaged between the set of handle acceptors (108). The set of handle acceptors (108) may be affixed against the reinforcement bars (106) to provide greater support and stability to the handlebar (114) for lifting and transport.

Referring to FIG. 3, a top view of the infused beverage storage container (100) is shown in accordance with an exemplary embodiment of the present invention. The top (104) is illustrated to show the opening (116). Through the opening (116), the lid (122) may be accessible to the user. The handlebar (114) may extend a distance from the holding box (102) to enable the user's hand and fingers to grip around the handlebar (114) for transport.

While the infused beverage storage container (100) provides a useful means for transportation, the contents may also be mixed and substituted depending on the preferences of the user. For example, a refreshing summer beverage recipe may be mixed and infused in the infusion jar (120). The refreshing summer beverage recipe comprises a combination of ingredients including a portion of ice, a portion of sliced lemons, a portion of vodka and a portion of sugar. The combination of ingredients is mixed within the infusion jar (120), and left to for infusion. Essentially, the combination of ingredients stored in the infusion jar (120) is a portion of alcohol, a portion of fruit and a portion of sugar. Besides vodka, alternative alcohols may be substituted like rum, tequila or gin. Likewise, different fruits may be used for the portion of fruit like oranges, pineapples, mangos, watermelon and the like. The options are open to the user depending on their likes and preferences.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. An infused beverage storage container comprising:
a holding box with a plurality of sides, where said plurality of sides compose a peripheral edge of said holding box;
a set of handle acceptors attached to a set of opposing sides;
a top attached to an upper portion of said holding box;
a set of handlebars engaged within said set of handle acceptors to lift said infused beverage storage container;
an infusion jar resting within said holding box;
a lid fastened to said infusion jar and extending from an opening within said top; and
a combination of ingredients to create an infused beverage wherein said infused beverage storage container is housed within said infusion jar and dispensed after removing said lid.

2. The infused beverage storage container of claim 1, wherein said infusion jar includes a threaded neck at an upper portion of said infusion jar to receive said lid.

3. The infused beverage storage container of claim 1, wherein said lid creates an airtight seal around said infusion jar.

4. The infused beverage storage container of claim 1, wherein said plurality of sides are secured with a plurality of reinforcement bars.

5. The infused beverage storage container of claim 1, wherein said holding box and said top are composed of a plastic resin.

6. The infused beverage storage container of claim 1, wherein said combination of ingredients includes a portion of alcohol, a portion of fruit and a portion of sugar.

7. The infused beverage storage container of claim 6, wherein said portion of alcohol comprises vodka and said portion of fruit comprises sliced lemons.
